(19) United States
(12) Patent Application Publication
(10) Pub. No.: US 2002/0075904 A1
(43) Pub. Date: Jun. 20, 2002

(54) Short training sequences for reacquisition of segmented data

(76) Inventors: Anand G. Dabak, Plano, TX (US); Timothy M. Schmidl, Dallas, TX (US); Mohammed Nafie, Giya (EG)

Correspondence Address: TEXAS INSTRUMENTS INCORPORATED, P O BOX 655474, M/S 3999, DALLAS, TX, 75265

(21) Appl. No.: 09/978,811

(22) Filed: Oct. 15, 2001

Related U.S. Application Data
(60) Provisional application No. 60/243,061, filed on Oct. 25, 2000.

(51) Int. Cl. G06F 17/00; H04J 3/06

(52) U.S. Cl. 370/510; 700/94

(57) ABSTRACT

A communication protocol divides the data payload (206) into segments (402, 404) with each of the payload segments (402, 404) providing a short synch word (406) which allows for an equalizer (104) to be retrained. This provides for improved performance during bursty interference conditions. The segmentation of the data also reduces the chances that the complete data in the payload has to be retransmitted due to bursty interference signals.

### TECHNICAL FIELD

This invention relates in general to the field of radio communications and more specifically to a communication protocol and method for providing short training sequences.

### BACKGROUND

In wireless communication protocols such as Bluetooth (including the yet to be finalized Bluetooth 2.0 standard) or the Institute of Electrical and Electronic Engineers (IEEE) 802.15.3 standard, the data packets that are transmitted are broken down into smaller segments for robustness against interference. Each segment is succeeded by a Cyclic Redundancy Checksum (CRC) at the end. No training is included in the beginning of each segment under the assumption that the channel may not change significantly when the interference occurs. This however ignores the effect of residual frequency error. Even with a residual frequency error of only +/−1 kHz (+/−0.4 parts-per-million accuracy) the phase drift during a 625 microsecond Bluetooth interference packet is +/−225 degrees. In the presence of decision feedback equalization, exact phase reference in the segments is required, which is not provided by current designs.

Although a proposed solution to the above noted problem is the introduction of differential encoding, it however is not enough to overcome an interference signal when decision feedback equalization has to be performed at the receiver. In the absence of an equalizer, in the currently proposed Bluetooth 2.0 standard, performance degrades in the presence of a delay spread and has a coverage of less than 90% in a 10 meter radius around a Bluetooth 2.0 device. Additional coding in the system, such as Reed-Solomon coding, etc. does not help solve the above problem. A need thus exists for a solution to the above-mentioned problem.

### BRIEF DESCRIPTION OF THE DRAWINGS

The features of the present invention, which are believed to be novel, are set forth with particularity in the appended claims. The invention, may best be understood by reference to the following description, taken in conjunction with the accompanying drawings, in the several figures of which like reference numerals identify like elements, and in which:

FIG. 1 is a block diagram of a receiver in accordance with the invention.

FIG. 2 shows a packet structure for use in a wireless system in accordance with the invention.

FIG. 3 illustrates a time-division-duplex (TDD) system using the packets of FIG. 2 in a Bluetooth system in accordance with the invention.

FIG. 4 shows a payload segment including using a sync field in each of the payload segments in accordance with the invention.

FIG. 5 shows a synchronization field as used in association with the packet in accordance with the present invention.

FIG. 6 illustrates a communication system in accordance with the invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures.

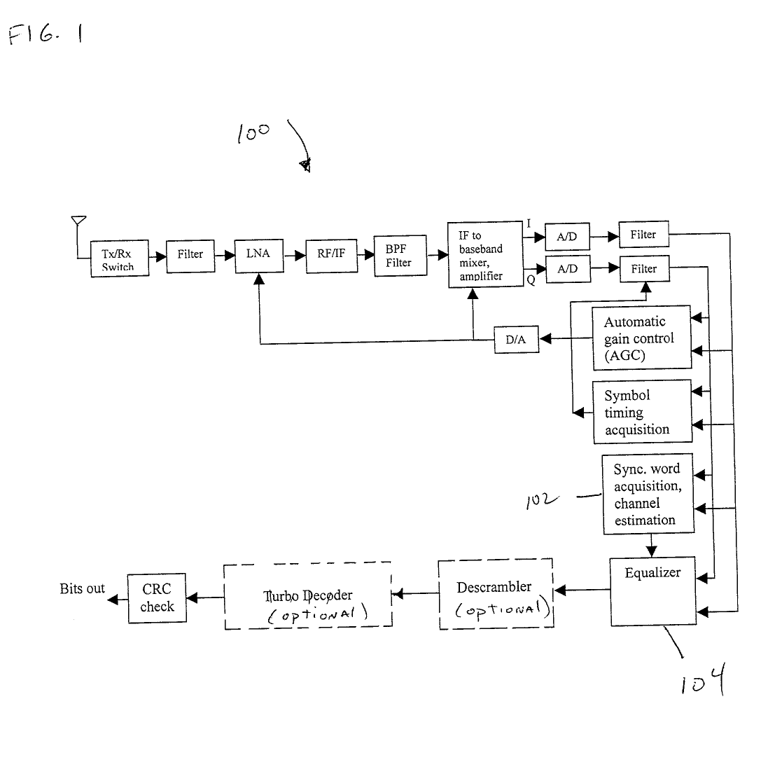

In FIG. 1 there is shown a receiver 100 in accordance with the invention. The receiver 100 in the preferred embodiment is designed to operate in a Bluetooth system. The receiver 100 includes a sync (synchronization) word acquisition and estimation block that is used to synchronize the receiver using the segmented payload sync words described further below. An equalizer 104 is used which uses the periodic synch words (406 in FIG. 4) for retraining. The equalizer 104 does away with the need of using diversity antenna systems in order to combat busty jamming causes by interfering signals. The equalizer is retrained through out a single packet (see 200 in FIG. 2) since the payload is broken up into multiple segments each having a sync word.

Referring now to FIG. 2, there is shown a packet structure 200 in accordance with the invention. Packet 200 includes a Sync (synchronization) field 202, an Automatic Repeat reQuest (ARQ) field 204 and a segmented payload (data) field 206. The Sync field 202 starts with a preamble 208 that aids in the initial symbol timing acquisition, carrier frequency offset estimation and channel estimation by the receiver in a wireless system like a Bluetooth system. An illustration of a Sync field 202 is shown in FIG. 2. Points used in the preamble are (1+j) PN and PN=[−1 −1 −1 −1 1 −1 −1 1 −1 1 1 −1 −1 1 1 1 1 1 −1 −1 −1 1 1 −1 1 1 1 −1 1 −1 1]. The ARQ field 204 follows the header 210, which contains link layer information. The header 210 and ARQ field 204 can either be repeated at a predetermined code rate (i.e., ⅕) or an alternate solution would be to repeat the header a predetermined number of times (i.e., 5 times). The header 210 provides such things as receive (RX) and transmit (TX) flow control information, modulation and coding information, etc. between a master and slave unit, information on the number of payload segments, etc. in a Bluetooth system. In the preferred embodiment the ARQ field 204 includes a bitmap field of between 1 and 63 bits, a Fill field of between 15 and 77 bits, and a CRC field of 32 bits. This provides for a total of 110 ARQ bits before coding.

In FIG. 4, there is shown an illustration of the payload 206 section, which in order to reduce the effect of interferers, is segmented in multiple payload segments 402, 404. Preferably in the payload, except for the sync word 406, which employs BPSK modulation, any of the 6 modulation and coding schemes used in Bluetooth can be used. The modulation and coding is the same over the whole payload packet. The payload 206, is divided into payload segments 402, 404, which are each protected with a 32-bit cyclic Redundancy Code (CRC) independently. The Turbo coding is applied over each segment. The sync field 406 is not protected by CRC.

The Sync field 406 is preferably 28 bits long, and is transmitted using antipodal Quadrature Phase Shift Keying (QPSK) modulation and is used for recovering from bursty interference. In the preferred embodiment, the sync field 406 is derived from PN 15 and is defined as follows:

(1+j)*[−1 −1 −1 1 1 1 1 −1 1 −1 1 1 −1 −1 1 −1 −1 −1 1 1 1 1 −1 1 −1 1 1 −1].

The sync field 406 found in the payload segments 402, 404 is preferably shorter in length than the sync field 202. The segment also includes a logical link ID (L_CH) field 408 of 4 bits, a 2-bit Frag field 410, which provides information for Logical Link Control and Adaptation Protocol (L2CAP) reassembly. A 10-bit Segment sequence Number field (SN) 412 for use in reassembly and ARQ, with the sequence numbers being independent for each logical link, including the control link. A 9-bit length field 414 informs the receiving unit of how many data bytes in the segment. A 1-bit flush field 416 provides the transmitter of the receiving device with information to indicate that the payload segments below the sequence number associated up to the currently received segment will not be transmitted. The flushing is done separately for all the logical links. A 4-bit field 418 is reserved for future features. The Data is carried in a Data field 420 that can range in size from 0-2080 bits. The final portion of the Segment 402 is a 2-bit tail field 422 that is used by the Turbo decoder in the receiver.

When using high data rates of transmission, as those proposed in the second release of Bluetooth (e.g., above 4 Mega-bits-per-second (Mbps)) with high delay spreads using an equalizer 104 improves the gain. At higher data rates 10 Mbps and above, the equalizer 104 using the sync word 406 retraining combined with segmenting the data as proposed by the present invention provides for much improved coexistence in the face of severe bursty interference.

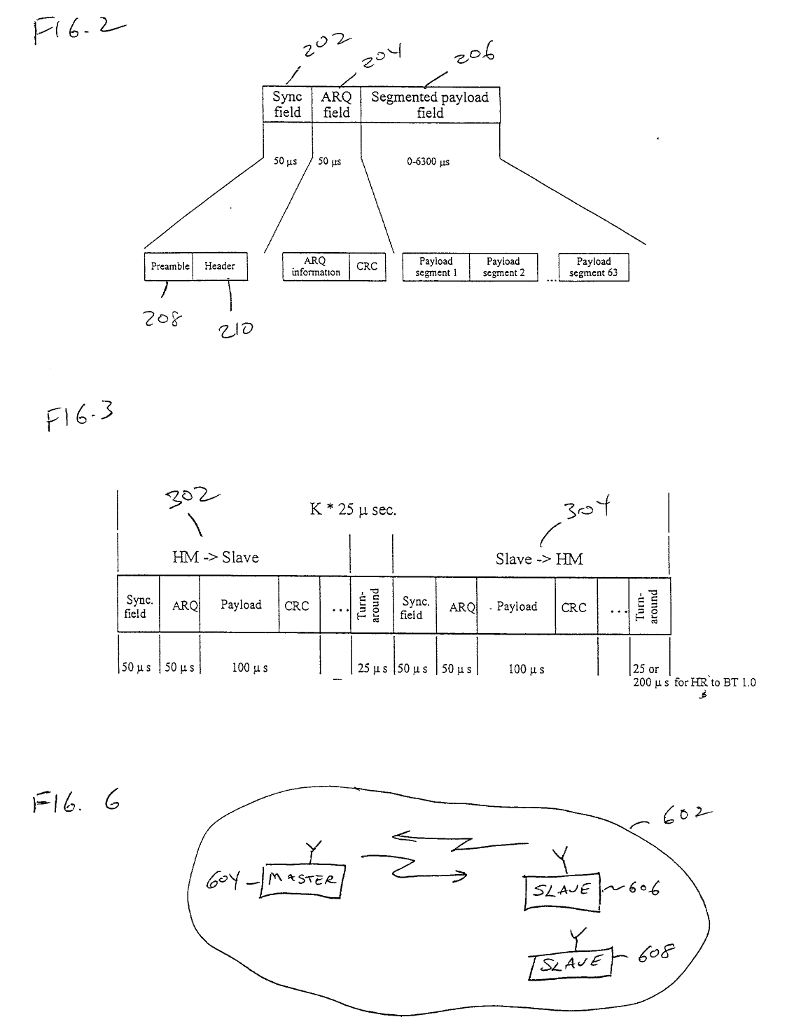

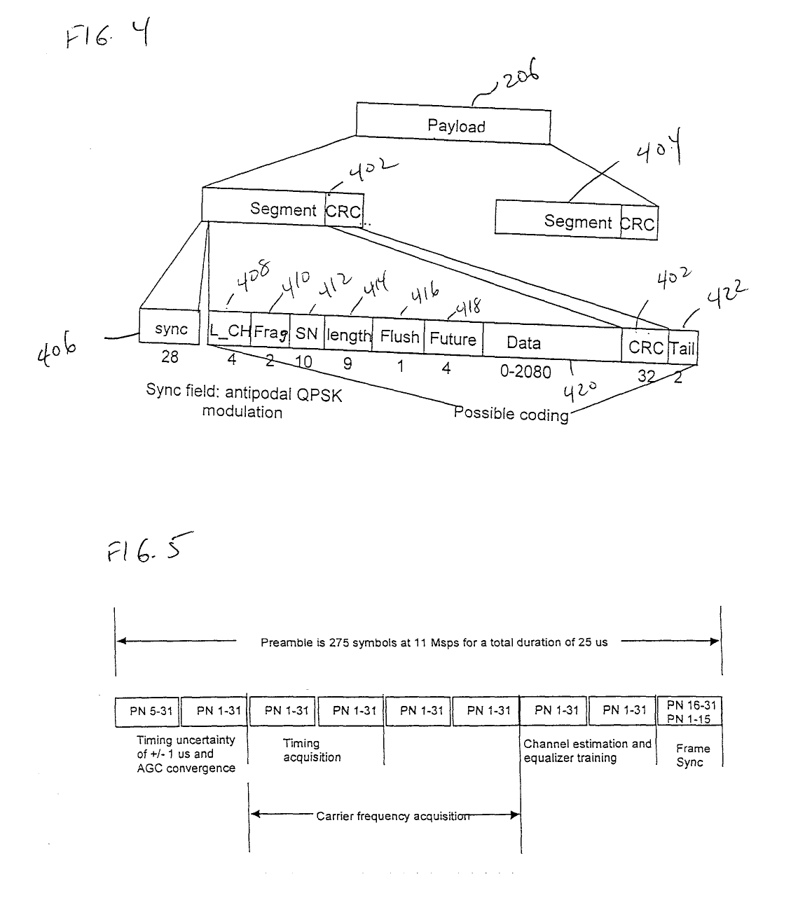

In FIG. 3, there is shown a TDD timeline showing communications between a master and a slave using the packets according to the invention. Section 302 shows communications from a Bluetooth master to a slave, and in section 304 communications from a slave to a master is shown. In FIG. 6 there is shown a communication system such as a Bluetooth piconet 602, which uses the segmented and synchronized payload of the present invention. The piconet 602 includes one master unit 604 and two slave units 606 and 608. Using the present invention's protocol, the devices can reduce the overhead effects caused by interference.

The present invention provides improved system performance in bursty interference conditions as when used in a Bluetooth system. The invention avoids large chunks of data from being lost even when faced with severe interference. Thereby reducing any throughput degradation caused by the interference. Rather than losing complete packets of data, using the payload segments 402 and 404 with include sync words 406 of the invention, helps to minimize degradation with minimal realization complexity. The periodic sync words 406 allow the equalizer 104 to be retrained with minimal protocol overhead, and vastly improving performance.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims. For example, although the present invention has been discussed in association with either a Bluetooth or IEEE 802.15.3 communication system, the present invention can be used in other communication systems that require the protection of data against interferers.

What is claimed is:

1. A communication protocol, comprising:
a data payload packet having a sync field, and the data payload packet is divided into a plurality of payload segments; and
each of the plurality of payload segments includes a shorter synchronization field than said data payload packet sync field.

2. A communication protocol as defined in claim 1, wherein the communication protocol is used in a Bluetooth system.

3. A communication protocol as defined in claim 1, wherein the communication protocol is used in an IEEE 802.15.3 system.

4. A communication protocol as defined in claim 1, wherein the synchronization fields in the payload segments are used to repeatedly retrain an equalizer during the transmission of the payload packet.

5. A communication protocol as defined in claim 1, wherein the synchronization field found in each of the payload segments is modulated using antipodal QPSK.

6. A communication protocol as defined in claim 1, wherein each of the payload segments further include a segment sequence number packet.

7. A method for reducing the effects of interference in a wireless communication system, comprising the steps of:
dividing a data payload having a synchronization (sync) field into a plurality of payload segments for transmission; and
providing a synchronization (sync) field in each of the plurality of payload segments that is shorter in length than the data payload sync field.

8. A method as defined in claim 7, wherein the sync field found in each of the payload segments, is the first field in each of the payload segments.

9. A method as defined in claim 7, further comprising the steps of:
transmitting the sync field followed by an ARQ field and then followed by the plurality of payload segments.

10. A method as defined in claim 9, wherein a receiver having an equalizer receives the transmission and the sync fields found in each of the paylaod segments is used to retrain the equalizer.

11. A method as defined in claim 7, wherein each of the sync fields is modulated using QPSK modulation.

12. A communication system comprising:
a transmitter for transmitting a data payload packet having a sync field and the data payload packet is divided into a plurality of payload segments with each payload segment including a synchronization (sync) word that is shorter in length than said data payload packet sync field; and
a receiver including an equalizer for receiving the data packet and using the synchronization words from each of the plurality of payload segments received to retrain the equalizer.

13. A communication system as defined in claim 12, wherein the transmitter and receiver operate in a Bluetooth system.

14. A communication system as defined in claim 12, wherein the data packet transmitted also includes an ARQ field.

15. A communication system as defined in claim 12, wherein the transmitter and receiver operate in an IEEE 802.15.3 system.
